(19) United States
(12) Patent Application Publication
(10) Pub. No.: US 2015/0149268 A1
(43) Pub. Date: May 28, 2015

(54) MOBILE COUPONING SYSTEM AND METHOD

(71) Applicant: MOBI724 SOLUTIONS INC., Westmount (CA)

(72) Inventor: Marcel VIENNEAU, Montreal (CA)

(21) Appl. No.: 14/482,995

(22) Filed: Sep. 10, 2014

(30) Foreign Application Priority Data
Nov. 25, 2013 (CA) 2834272

(51) Int. Cl. G06Q 30/02

(52) U.S. Cl. CPC G06Q 30/0222; G06Q 30/0225
USPC 705/14.23

(57) ABSTRACT

There is provided a method and a system for enabling a transaction using electronic coupons. The method comprises assigning an electronic coupon to a given customer and transmitting information related to the electronic coupon to a mobile device of the given customer. In the course of the transaction, a predetermined issuer identification number (IIN) is provided in a payment terminal of a merchant and the predetermined IIN is detected by a payment gateway of a payment processing entity operatively connected to the payment terminal. An indication of a financial benefit associated with the use of the electronic coupon is retrieved from a database and is provided to the merchant such that the given customer is provided with the financial benefit upon completion of the transaction.

### TECHNICAL FIELD

Embodiments of the disclosed technology generally pertain to couponing, and more specifically to mobile couponing systems and methods.

### BACKGROUND

Merchants (i.e. manufacturers and retailers) have used coupons as a marketing tool for many years. A coupon is a token which can be redeemed during a financial transaction, such as the purchase of a product, to provide some type of benefit to the purchaser. The benefit may include, but is not limited to, a discount on a specific product when the product is purchased in a specific store, a discount on any purchase made in a specific store, a discount on a second product when a first product is purchased or a free second product when a first product is purchased.

Traditionally, coupons are tickets which are printed on a document such as a flyer, a newspaper or a magazine. The document is distributed to a customer through regular mail or other means, and the customer has to cut the coupon out of the document and bring the coupon to a retail store to redeem it. Printed coupons are therefore usually sized and shaped to easily fit in a pocket or a wallet of the customer. Printed coupons usually include information such as the name of the retail store, an amount of a discount to be applied to a transaction made using the coupon and/or an expiry date of the coupon.

More recently, some merchants have turned to mobile couponing to distribute coupons to customers. “Mobile couponing” is the act of sending an electronic coupon to a mobile device owned by a customer. The electronic coupon comprises data similar to the information found on a printed coupon, but in electronic format. Since a relatively large portion of the population owns a mobile device such as a mobile phone or a smart phone, mobile couponing enables a retailer to distribute coupons to a relatively large number of customers and potential customers. Mobile couponing further facilitates the use of coupons by eliminating the need to cut the coupon from a document or by eliminating the need to carry around an extra item, since most people nowadays carry their mobile device with them when they are out shopping.

Coupon usage by customers may be monitored and/or managed using a mobile couponing system. For instance, each coupon used could be tracked by a system to ensure that the coupon is only used once. Furthermore, merchants may want to track coupons used for a particular user to gather data on the particular user's shopping habits, in order to adjust the frequency at which electronic coupons are sent to the particular user and/or the type of products on which a discount is provided by the electronic coupons sent to the particular user.

Unfortunately, setting up and managing a mobile couponing system may be relatively expensive and complex, and therefore mobile couponing remains relatively inaccessible to most merchants.

There is therefore a need for a couponing system and a couponing method which would overcome at least one of the above-identified drawbacks.

### BRIEF SUMMARY

According to one aspect, there is provided a method for enabling a transaction using electronic coupons, the method comprising providing a customer database comprising, for each customer of a plurality of customers, a corresponding customer contact parameter for enabling a communication with a mobile device of the customer; assigning an electronic coupon to a given customer, the assigning comprising storing an indication of said electronic coupon in said customer database; transmitting a predetermined issuer identification number (IIN) and information related to said electronic coupon to the mobile device of the given customer for use thereof in a transaction involving a payment terminal of a merchant; in the course of the transaction, receiving an indication of a use of the electronic coupon, the receiving comprising the predetermined IIN being provided in the payment terminal of the merchant and being detected by a payment gateway of a payment processing entity operatively connected to the payment terminal, the receiving further comprising the indication of the electronic coupon being provided by said payment gateway upon detection of the predetermined IIN; retrieving from the customer database an indication of a financial benefit associated with the use of the electronic coupon; providing to the merchant the indication of the financial benefit such that the given customer is provided with the financial benefit upon completion of the transaction.

In one embodiment, the indication of said electronic coupon comprises a coupon identification specific to said electronic coupon.

In one embodiment, the coupon identification comprises the predetermined IIN.

In another embodiment, the indication of said electronic coupon comprises a customer identification associated with the given customer and a merchant identification associated with the merchant.

In one embodiment, the transmitting of the predetermined IIN and of the information related to said electronic coupon comprises transmitting the predetermined IIN and of the information related to said electronic coupon over a cellular network.

In one embodiment, the information related to said electronic coupon comprises a text message indicative of the electronic coupon.

In one embodiment, the text message comprises an SMS text message.

In one embodiment, the method further comprises storing at least one parameter of the transaction in the customer database and associating said at least one parameter to the given customer.

In one embodiment, the at least one parameter of the transaction is selected from a group consisting of: an indication that the electronic coupon was used, a time at which the transaction was made, an initial amount of the transaction, a discounted amount of the transaction, a type of product purchased and a type of service purchased.

In one embodiment, the method further comprises assigning a plurality of electronic coupons to the given customer and transmitting information related to each one of said plurality of electronic coupons to the mobile device of the given customer.

In one embodiment, the method further comprises recording a plurality of parameters, each parameter corresponding to one of a plurality of transactions made by the given customer.

In one embodiment, the method further comprises analyzing the customer database to determine a consumer behavior of the given customer based on the plurality of recorded parameters.

In one embodiment, the assigning of the electronic coupon to the given customer comprises selecting the electronic coupon based on the consumer behavior of the given customer.

In one embodiment, the assigning of the electronic coupon to the given customer comprises selecting the electronic coupon based on a coupon parameter selected by the given customer.

In one embodiment, the coupon parameter is selected from a group consisting of: a geographical location, at least one type of product, at least one type of service and at least one predetermined merchant.

In one embodiment, the assigning of the electronic coupon to the given customer comprises: upon detection that the given customer is at a predetermined distance of a predetermined merchant, selecting the electronic coupon based on the predetermined merchant, the electronic coupon being redeemable at said predetermined merchant.

In one embodiment, the transaction comprises a purchase.

In one embodiment, the financial benefit comprises a discount on the purchase.

In one embodiment, the providing of the indication of the financial benefit to the merchant comprises: obtaining an initial amount of the purchase from the merchant; applying the discount to the initial amount to determine a discounted amount; providing the discounted amount to the merchant.

In one embodiment, the predetermined IIN conforms to the ISO/IEC 7812 standard.

In one embodiment, the providing of the customer database comprises providing a remote access interface operatively connected to the customer database for enabling interaction with the customer database.

In one embodiment, the remote access interface is accessible via a data network.

In one embodiment, the data network comprises the Internet.

In one embodiment, the remote access interface provides a web-based user interface.

In one embodiment, the method further comprises, after receiving the indication of the use of the electronic coupon, providing an indication that the electronic coupon is redeemable in the transaction.

In one embodiment, the indication that the electronic coupon is redeemable is provided to at least one of the given customer and the merchant.

In one embodiment, the indication that the electronic coupon is redeemable comprises an indication that the electronic coupon was not already redeemed in another transaction.

In one embodiment, the corresponding customer contact parameter is selected from a group comprising a mobile phone number of the mobile device of the given customer, an e-mail address of the given customer, an IP address of the given customer, an international mobile subscriber identity (IMSI) number of the mobile device of the given customer, a MAC address of the mobile device of the given customer.

According to another aspect, there is provided a system for enabling a transaction using electronic coupons, the system comprising: a customer database for storing, for each customer of a plurality of customers, a corresponding customer contact parameter for enabling a communication with a mobile device of the customer, the customer database being further adapted for storing an indication of an electronic coupon assigned to a given customer, the customer database being further adapted for storing an indication of a financial benefit associated with the use of the electronic coupon in a transaction; a communication port operatively connected to the customer database and adapted to communicate with a payment gateway of a payment processing entity; a coupon processing unit operatively connected to the customer database and to the communication port, the coupon processing unit being adapted to receive from the communication port a first signal indicative of a detection by the payment gateway of a predetermined issuer identification number (IIN) provided in a payment terminal associated with a transaction and operatively connected to the payment gateway, the first signal being further indicative of said electronic coupon, the coupon processing unit being further adapted to lookup in the customer database the indication of the electronic coupon corresponding to the first signal, the coupon processing unit being further adapted to retrieve from the customer database a corresponding indication of the financial benefit associated with the use of the electronic coupon corresponding to the first signal, the coupon processing unit being further adapted to provide to the communication port a second signal indicative of the corresponding indication of the financial benefit.

In one embodiment, the indication of the electronic coupon comprises a coupon identification specific to said electronic coupon.

In one embodiment, the coupon identification comprises the predetermined IIN.

In another embodiment, the indication of the electronic coupon comprises a customer identification associated with the given customer and a merchant identification associated with the merchant.

In one embodiment, the predetermined IIN comprises one of a plurality of IINs associated with the system.

In one embodiment, the predetermined IIN conforms to the ISO/IEC 7812 standard.

In one embodiment, the coupon processing unit is further adapted to generate the electronic coupon based on at least one criteria provided by the merchant.

In one embodiment, the communication port is further adapted to communicate with the mobile device of the given customer using the corresponding customer contact parameter.

In one embodiment, the communication port is adapted for transmitting information related to the electronic coupon to the mobile device over a cellular network.

In one embodiment, the information related to the electronic coupon comprises a text message indicative of the electronic coupon.

In one embodiment, the text message comprises an SMS text message.

In one embodiment, the system further comprises a remote access interface operatively connected to the customer database for enabling interaction with the customer database.

In one embodiment, the remote access interface is further adapted to enable the merchant to provide at least one criteria for generating the electronic coupon.

In one embodiment, the data network comprises the Internet.

In one embodiment, the remote access interface provides a web-based user interface.

According to yet another aspect, there is also provided a system for enabling a transaction using electronic coupons, the system comprising: a customer database for storing, for each customer of a plurality of customers, a corresponding customer contact parameter for enabling a communication with a mobile device of the customer, the customer database being further adapted for storing an indication of an electronic coupon assigned to a given customer, the customer database being further adapted for storing an indication of a financial benefit associated with the use of the electronic coupon in a transaction; a payment gateway operatively connected to a payment terminal of a merchant, the payment gateway being adapted to detect a predetermined issuer identification number (IIN) provided in the payment terminal and being further adapted to provide a first signal indicative of the detection of said predetermined IIN, the first signal being further indicative of said electronic coupon; a coupon processing unit operatively connected to the customer database and to the payment gateway, the coupon processing unit being adapted to receive the first signal from the payment gateway, the coupon processing unit being further adapted to lookup in the customer database the indication of the electronic coupon corresponding to the first signal, the coupon processing unit being further adapted to retrieve from the customer database a corresponding indication of the financial benefit associated with the use of the electronic coupon corresponding to the first signal, the coupon processing unit being further adapted to provide to the payment gateway a second signal indicative of the corresponding indication of the financial benefit.

In one embodiment, there is also provided a method for enabling a transaction using electronic coupons, the method comprising: providing a customer database comprising, for each customer of a plurality of customers, a corresponding customer contact parameter for enabling a communication with a mobile device of the customer; assigning an electronic coupon to a given customer, the assigning comprising storing an indication of said electronic coupon in said customer database, the indication of said electronic coupon comprising a coupon issuer identification number (IIN) specific to said electronic coupon; transmitting the indication of said electronic coupon to the mobile device of the given customer for use thereof in a transaction involving a payment terminal of a merchant; in the course of the transaction, receiving an indication of the coupon IIN provided in the payment terminal of the merchant, the receiving comprising the coupon IIN being detected by a payment gateway of a payment processing entity operatively connected to the payment terminal, the indication of the coupon IIN being provided by said payment gateway; retrieving from the customer database using the indication of the coupon IIN an indication of a financial benefit associated with the use of the electronic coupon; providing to the merchant the indication of the financial benefit such that the given customer is provided with the financial benefit upon completion of the transaction.

In another embodiment, there is also provided a system for enabling a transaction using electronic coupons, the system comprising: a customer database for storing, for each customer of a plurality of customers, a corresponding customer contact parameter for enabling a communication with a mobile device of the customer, the customer database being further adapted for storing an indication of an electronic coupon assigned to a given customer, the electronic coupon comprising a coupon issuer identification number (IIN) specific to said electronic coupon, the customer database being further adapted for storing an indication of a financial benefit associated with the use of the electronic coupon in a transaction; a communication port operatively connected to the customer database and adapted to communicate with a payment gateway of a payment processing entity; a coupon processing unit operatively connected to the customer database and to the communication port, the coupon processing unit being adapted to receive from the communication port a first signal indicative of a detection by the payment gateway of the coupon IIN provided in a payment terminal associated with a transaction and operatively connected to the payment gateway, the coupon processing unit being further adapted to lookup in the customer database the coupon IIN corresponding to the first signal, the coupon processing unit being further adapted to retrieve from the customer database a corresponding indication of the financial benefit associated with the use of the electronic coupon corresponding to the coupon IIN detected by the payment gateway, the coupon processing unit being further adapted to provide to the communication port a second signal indicative of the corresponding indication of the financial benefit.

In yet another embodiment, there is also provided a system for enabling a transaction using electronic coupons, the system comprising: a customer database for storing, for each customer of a plurality of customers, a corresponding customer contact parameter for enabling a communication with a mobile device of the customer, the customer database being further adapted for storing an indication of an electronic coupon assigned to a given customer, the electronic coupon comprising a coupon issuer identification number (IIN) specific to said electronic coupon, the customer database being further adapted for storing an indication of a financial benefit associated with the use of the electronic coupon in a transaction; a payment gateway operatively connected to a payment terminal of a merchant, the payment gateway being adapted to detect the coupon issuer identification number (IIN) provided in the payment terminal and being further adapted to provide a first signal indicative of the detection of said coupon IIN; a coupon processing unit operatively connected to the customer database and to the payment gateway, the coupon processing unit being adapted to receive the first signal from the payment gateway, the coupon processing unit being further adapted to lookup in the customer database the coupon issuer identification number (IIN) corresponding to the first signal, the coupon processing unit being further adapted to retrieve from the customer database a corresponding indication of the financial benefit associated with the use of the electronic coupon corresponding to the coupon issuer identification number (IIN) detected by the payment gateway, the coupon processing unit being further adapted to provide to the payment gateway a second signal indicative of the corresponding indication of the financial benefit.

### BRIEF DESCRIPTION OF THE DRAWINGS

Embodiments of the disclosed technology are illustrated by way of example in the accompanying drawings.

FIG. 1 is a schematic diagram showing a mobile couponing system, in accordance with one embodiment.

FIG. 2 is a flowchart showing a method for enabling a transaction using electronic coupons, in accordance with one embodiment.

FIG. 3 is a flowchart showing a method for assigning electronic coupons based on consumer behavior, in accordance with one embodiment.

FIG. 4 is a schematic diagram showing a mobile couponing system, in accordance with another embodiment.

FIG. 5 is a schematic diagram showing a mobile couponing system, in accordance with yet another embodiment.

### DETAILED DESCRIPTION

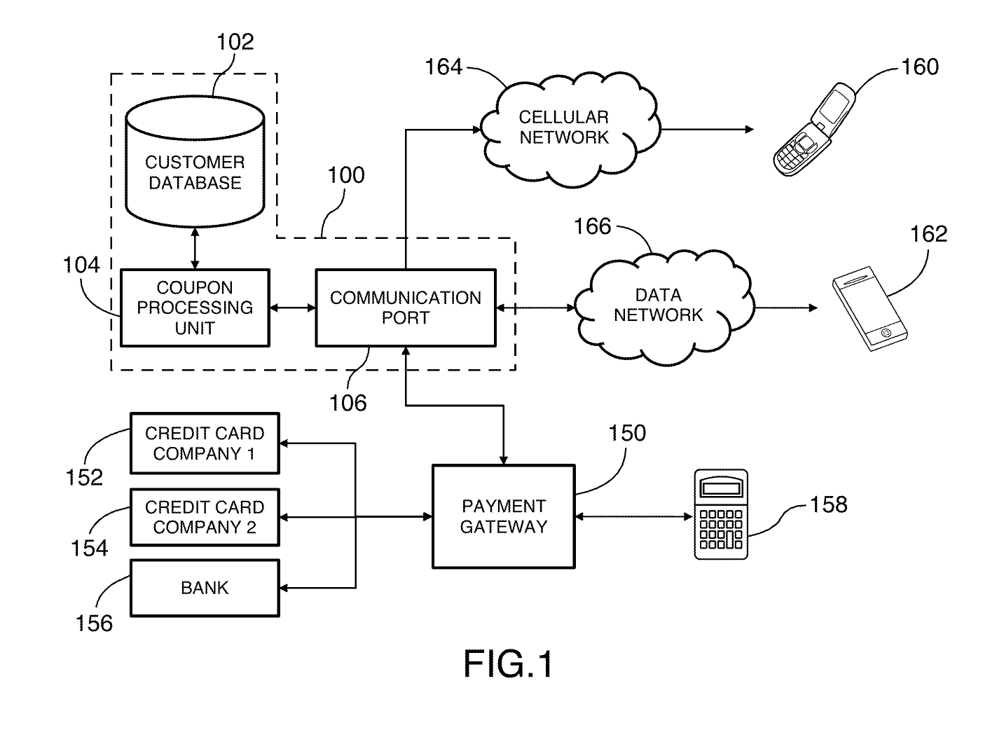

Referring first to FIG. 1, there is shown a mobile couponing system 100, in accordance with one embodiment. The mobile couponing system 100 is configured to be used with a payment gateway 150, such as an existing payment gateway of a payment processing entity. The term “payment processing entity” includes any company which handles payment card transactions for a merchant (e.g. using a credit card or a debit card). A payment gateway is typically used by a payment processing entity to route information related to a payment card purchase, including an amount of the purchase and an identification of the payment card used to make the purchase, to a credit card company or a bank corresponding to the payment card used in the purchase. In the illustrated embodiment, the payment gateway 150 is operatively connected to a first credit card company system 152, a second credit card company system 154 and a bank system 156. For example, the first credit card company system may be the Visa™ system of Visa Inc. (Foster City, Calif.), while the second credit card company system may be the MasterCard™ system of MasterCard Inc. (Purchase, N.Y.). It will be appreciated that the payment gateway 150 may be connected to a different number and/or different types of financial institutions which process card payment information.

It will also be appreciated that most credit card companies and other financial institutions provide cards which comprise an issuer identification number (IIN) which is specific to said credit card company or financial institution. Payment gateways are typically adapted to detect this IIN during a transaction involving a payment card and to route the transaction information to the corresponding credit card company or financial institution. The IIN is usually provided in a payment terminal 158 of a merchant which is operatively connected to a payment gateway, by swiping the card or by entering the IIN in a numerical keypad, for example. The IIN used in those types of cards is generally selected in accordance with the ISO/IEC 7812 standard. The ISO/IEC 7812 standard is an international standard used to generate identification numbers for cards such as debit cards, credit cards and airline miles card. According to this standard, each card comprises a six-digit IIN which is specific to the issuer of the card and at least one other numeral which is specific to the card.

In the illustrated embodiment, the system 100 comprises a customer database 102 and a coupon processing unit 104 operatively connected to the customer database 102. The system 100 further comprises a communication port 106 operatively connected to the customer database 102 and to the coupon processing unit 104, the communication port 106 being adapted to communicate with the payment gateway 150.

When the present system 100 is used, one or more electronic coupon is assigned to each one of a plurality of customers for use in a transaction to provide a financial benefit to the customer, as explained below. When an electronic coupon is used in a transaction, a predetermined IIN associated with the system 100 is provided in the payment terminal 158 of a merchant. As explained above, payment gateways are generally adapted to detect the card's IIN and to route the payment information to the proper issuer according to the detected IIN. Therefore, by selecting a predetermined IIN which is similar to a card's IIN, i.e. a predetermined IIN which comprises six digits, the predetermined IIN is in an appropriate format to be detected by the payment gateway 150. By selecting a predetermined IIN which is specific to the mobile couponing system, the payment gateway 150 will determine by the detected IIN that an electronic coupon is used in a transaction and will properly route the information related to the transaction.

It will be appreciated that payment terminals connected to such a payment gateway are already provided by most merchants at the merchant's store to enable purchases using a payment card. By using an existing payment gateway to which a merchant is already connected, the present mobile couponing system may enable a relatively large number of merchants to use a mobile couponing system without having to pay the relatively large fees required to set up and maintain a mobile couponing system by themselves. The mobile couponing system 100 may also enable a plurality of customers to receive coupons from a relatively large number of stores and to redeem their coupons at these stores.

In one embodiment, only as single predetermined IIN is associated with the system 100. The same IIN is therefore provided in the payment terminal in every transaction in which electronic coupons are used. In another embodiment, the predetermined IIN comprises one of a plurality of IINs associated with the system. In this embodiment, the payment gateway 150 is adapted to determine that each one of this plurality of IINs is associated with the use of an electronic coupon.

Still referring to the embodiment illustrated in FIG. 1, the customer database 102 is adapted for storing, for each customer, a corresponding customer contact parameter for enabling a communication with a mobile device of the customer.

In one embodiment, the mobile device of the customer comprises a mobile phone 160. In another embodiment, the mobile device instead comprises a smartphone 162. A skilled person will understand that the term “smartphone” is used to describe a mobile device which has additional computing capabilities, such as the ability to execute programs designed for smartphones, and/or additional connection capabilities, such as the ability to connect to Wi-Fi networks for example. Alternatively, the mobile device may comprise any mobile device which enables communication with the customer.

In an embodiment wherein the mobile device comprises a mobile phone, the corresponding customer contact parameter may comprise a mobile phone number of the mobile phone. Alternatively, the corresponding customer contact parameter may comprise an e-mail address, an international mobile subscriber identity (IMSI) number, an IP address, a MAC address of the mobile device of the given customer or any other identification that a skilled person would consider appropriate.

It will be appreciated that the customer database 102 may further be adapted for storing, for each customer, more than one customer contact parameter. For instance, the customer database 102 may further be adapted for storing, for each customer, an e-mail of the customer and a mobile phone number of the customer.

The customer database 102 is further adapted for storing an indication of an electronic coupon assigned to a given customer. This indication of the electronic coupon enables information related to the electronic coupon to be retrieved, as explained below.

In one embodiment, the indication of the electronic coupon comprises a coupon identification which is unique to each coupon. For example, the coupon identification of a given electronic coupon may comprise a unique digit or a unique digit sequence.

In another embodiment, the indication of the electronic coupon comprises the predetermined IIN itself, which is unique to each coupon. As explained above, the IIN may conform to the ISO/IEC 7812 standard. In this embodiment, the predetermined IIN is used to enable the payment gateway 150 to forward the information related to the transaction to the communication port 106, and also to identify the electronic coupon used in the transaction.

In yet another embodiment, the indication of the electronic coupon comprises a plurality of variables which enable the electronic coupon to be identified. For example, the indication of said electronic coupon may comprise a customer identification associated with the given customer and a merchant identification associated with the merchant where the electronic coupon may be redeemed. In this embodiment, the customer identification and the merchant identification may be stored in the customer database 102. Alternatively, the customer identification may be stored in the customer database 102 and the merchant identification may be stored in a merchant database which is distinct from the customer database 102, but which is operatively connected to the customer database 102.

In one embodiment, the given customer may be assigned a plurality of electronic coupons which are redeemable at a same merchant. In this case, the indication of the electronic coupon may further comprise, in addition to the customer identification and the merchant identification, a coupon identification as described above to determine which electronic coupon is being used in the transaction. In another embodiment, electronic coupons may be only be assigned to a given customer one at a time, such that if an electronic coupon redeemable at a given merchant is assigned to the given customer, the given customer must use this electronic coupon before another electronic coupon redeemable at the same given merchant can be assigned to him or her.

Alternatively, the electronic coupons may be identified using other variables or parameters known to the skilled addressee.

The customer database 102 is further adapted for storing an indication of the financial benefit associated with the use of the electronic coupon.

In one embodiment, the financial benefit is a discount on a price of a product or a service. The discount may comprise a discount amount to be subtracted from the price, or a percentage of the price to be subtracted from the price. In another embodiment, the financial benefit may comprise awarding a free product or service when a similar product or service is purchased. In yet another embodiment, the financial benefit may comprise awarding a free product or service when a different product or service is purchased. In yet another embodiment, the financial benefit may comprise a free product or service or a discount on a product or service when a predetermined number of similar products or services are purchased. In yet another embodiment, the financial benefit may comprise a discount on a price on a subsequent purchase. In yet another embodiment, the financial benefit may comprise a predetermined number of points or tokens which can be accumulated and redeemed on one or more subsequent purchases.

It will be appreciated that various other financial benefits may be provided when the electronic coupon is used in a transaction. In one embodiment, the financial benefit is determined by a “rule” which can be selected by the operator of the mobile couponing system or by a merchant associated with the mobile couponing system, as explained further below.

The coupon processing unit 104 is adapted to receive from the communication port 106 a first signal indicative of a detection by the payment gateway 150 of the predetermined IIN provided in the payment terminal 158.

In one embodiment, the first signal comprises the predetermined IIN, which is transmitted from the payment terminal 158 via the payment gateway 150 and through the communication port 106. Alternatively, the first signal may be generated further downstream by the payment gateway 150 when the predetermined IIN is detected by the payment gateway 150. In yet another embodiment, an indication of the detection of the predetermined IIN is transmitted by the payment gateway 150 to the communication port 106, which then generates the first signal based on the indication of the detection. The first signal enables the coupon processing unit 104 to detect that the electronic coupon is used in a transaction.

In another embodiment, the first signal is selected from a group consisting of: an e-mail indicative of the predetermined IIN and a text message indicative of the coupon IIN. For example, the e-mail or text message could include text in which at least a portion of this text is the predetermined IIN. It will be appreciated that the first signal may comprise any signal indicative of the detection of the predetermined IIN by the payment gateway 150.

The first signal is also indicative of the electronic coupon which is being used in the transaction. In an embodiment in which the electronic coupon is identified using the predetermined IIN, the first signal comprises the predetermined IIN which is used to identify the corresponding electronic coupon. In an embodiment in which the electronic coupon is identified using the coupon identification, the first signal comprises an indication of the coupon identification. In an embodiment in which the electronic coupon is identified using the customer identification and the merchant identification, the first signal comprises an indication of the customer identification and the merchant identification to enable the electronic coupon used in the transaction to be identified.

The first signal may also include additional information, such as an amount of the transaction, an indication of an article or a service involved in the transaction, or any other information related to the transaction.

The coupon processing unit 104 is further adapted to lookup in the customer database 102 the indication of the electronic coupon corresponding to the first signal, and to retrieve from the customer database 102 a corresponding indication of the financial benefit associated with the use of the electronic coupon corresponding to first signal. In one embodiment, the coupon processing unit 104 looks up the indication of the electronic coupon in the customer database 102 using the predetermined IIN. In another embodiment, the coupon processing unit 104 looks up the indication of the electronic coupon in the customer database 102 using the coupon identification. In yet another embodiment, the coupon processing unit 104 looks up the indication of the electronic coupon in the customer database 102 using both the customer identification and the merchant identification.

The coupon processing unit 104 is further adapted to provide to the communication port 106 a second signal indicative of the corresponding indication of the financial benefit retrieved from the customer database 102. As explained above, the financial benefit could be a discount on a purchase, for example. In one embodiment, the coupon processing unit 104 could be adapted to apply the discount to an initial price of the purchase in order to obtain a discounted price. In this embodiment, the second signal provided to the communication port 106 could comprise the discounted price. An indication of the discounted price could then be transmitted to the merchant via the payment gateway 150, such that the merchant may enable the customer to purchase an article or a service at the discounted price.

In another embodiment, the second signal merely comprises the discount. An indication of the discount could then be transmitted to the merchant via the payment gateway 150, such that the merchant may apply the discount to the price of the purchase to obtain the discounted price and enable the customer to purchase an article or a service at the discounted price.

In one embodiment, the system 100 is further adapted for transmitting information related to the electronic coupon to the mobile device. More specifically, the communication port 106 may be adapted to communicate with the mobile device of the given customer using the corresponding customer contact parameter, and to transmit the information related to the electronic coupon to the mobile device of the customer. The information related to the electronic coupon may comprise an expiry date of the electronic coupon, one or more specific stores, retailers or manufacturers where the coupon may be redeemed, an indication of a discount provided if the electronic coupon is used in a purchase, or any other information relevant to the electronic coupon.

In one embodiment, the information related to the electronic coupon comprises a text message indicative of the electronic coupon, such as an SMS text message. The text message may comprise the predetermined IIN, as well as an indication of the financial benefit associated with the use of the electronic coupon in a transaction.

In an embodiment wherein the mobile device comprises a mobile phone, the communication port 106 is adapted to communicate with the mobile phone 160 over a cellular network 164. It will be appreciated that such cellular networks are present and operational in most urban centers around the world, and in other regions as well. By transmitting electronic coupons to customers via an existing cellular network, the operator of the mobile couponing system 100 may advantageously send electronic coupons to a relatively large number of customers without having to create a dedicated communication network, which could be complex and expensive.

In the embodiment illustrated in FIG. 1, the communication port 106 is adapted to communicate with the mobile phone 160 over the cellular network 164 and also with the smartphone 162 over a data network 166 such as the Internet. This enables the system 100 to communicate with a plurality of customers in which some customers have a mobile phone and other customers have a smartphone and would receive a data message such as an e-mail or a native notification instead of a text message such as an SMS text message.

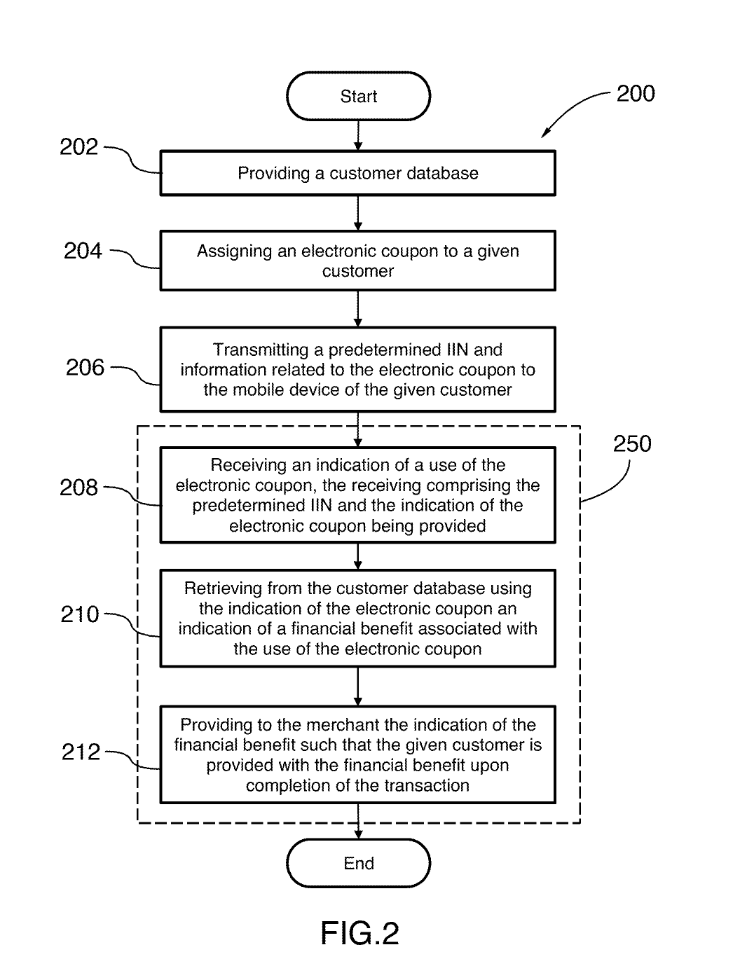

Now referring to FIG. 2, a method 200 for enabling a transaction using electronic coupons will now be described, in accordance with one embodiment.

According to step 202, a customer database, such as customer database 102 illustrated in FIG. 1, is provided. As explained above, the customer database 102 comprises, for each customer of a plurality of customers, a corresponding customer contact parameter for enabling a communication with a mobile device of the customer, such as the mobile phone 160 or the smartphone 162 illustrated in FIG. 1.

According to step 204, an electronic coupon is assigned to a given customer, and an indication of the electronic coupon is stored in the customer database. It will be appreciated that a plurality of coupons may be assigned to each given customer.

According to step 206, a predetermined issuer identification number (IIN) and information related to the electronic coupon is transmitted to the mobile device of the given customer for use thereof in a transaction 250 involving a payment terminal of a merchant, such as a purchase for example. In one embodiment, the transmitting of the predetermined IIN and of the information related to the electronic coupon comprises transmitting the predetermined IIN and of the information related to said electronic coupon over a cellular network. In this embodiment, the information related to the electronic coupon may comprise a text message indicative of the electronic coupon such as an SMS text message, as explained above.

The following steps 208, 210 and 212 are performed during the transaction 250, as illustrated in FIG. 2. According to step 208, the predetermined IIN is provided in the payment terminal of the merchant. In one embodiment, the predetermined IIN is read by the customer on his or her mobile device and then entered on a numeric keypad of the payment terminal by the customer. Alternatively, the customer may provide the predetermined IIN to the merchant, who then enters the predetermined IIN on the numerical keypad. In yet another embodiment in which the mobile device of the customer comprises a smartphone, the predetermined IIN may be provided as a scannable object such as a barcode or a QR code, which is scanned by the customer or the merchant using a scanner operatively connected to the payment terminal. The scannable object may further comprise an indication of a corresponding customer identification of the given customer. It will be appreciated that other means of providing the coupon IIN which are known to the skilled addressee may be used.

The indication of the electronic coupon is also provided in the payment terminal of the merchant to enable the electronic coupon used in the transaction to be identified. In one embodiment, the indication of the electronic coupon comprises the predetermined IIN itself, which is provided in the payment terminal as described above. In another embodiment, the indication of the electronic coupon comprises a coupon identification corresponding to the electronic coupon used in the transaction. In yet another embodiment, the indication of the electronic coupon comprises the customer identification corresponding to the given customer and the merchant identification corresponding to the merchant, such that the combination of the customer and the merchant identifications enables the electronic coupon to be identified. Both the customer identification and the merchant identification may be provided in the payment terminal, or the payment terminal may be adapted to automatically provide the corresponding merchant identification.

The predetermined IIN is then detected by a payment gateway of a payment processing entity, such as payment gateway 150 illustrated in FIG. 1, which is operatively connected to the payment terminal. The indication of the electronic coupon is then provided by the payment gateway to a mobile couponing system, such as the mobile couponing system 100 illustrated in FIG. 1.

According to step 210, an indication of a financial benefit associated with the use of the electronic coupon is retrieved from the customer database using the indication of the electronic coupon provided by the payment gateway.

According to step 212, the indication of the financial benefit is provided to the merchant such that the given customer is provided with the financial benefit upon completion of the transaction. For example, the financial benefit may comprise a discount on the purchase of an article. In one embodiment, an initial amount of the purchase is obtained from the merchant, via the payment gateway. The discount which is retrieved from the customer database is then applied to the initial amount to determine a discounted amount of the purchase. The discounted amount is then provided to the merchant, via the payment gateway for example. The customer may then purchase the article directly at the discounted amount, which eliminates the need for the merchant to calculate the discounted amount.

In one embodiment, after the indication of the electronic coupon is received, the validity of the electronic coupon is verified. More specifically, the method 200 may comprise verifying that the electronic coupon is redeemable in the transaction. During or after a transaction in which a given electronic coupon is used, an indication that the electronic coupon was redeemed could be provided and stored in the customer database. Alternatively, the indication of the electronic coupon may simply be removed from the database. In a subsequent transaction in which an indication of the electronic coupon corresponding to the same given electronic coupon is provided, the indication that the electronic coupon was already redeemed may be detected when the indication of the electronic coupon is received. Alternatively, it may be detected that the indication of the electronic coupon is no longer in the customer database. It will therefore be determined that the electronic coupon has already been redeemed in a previous transaction, or that the electronic coupon is not valid.

It will be appreciated that the electronic coupon may be non-redeemable or invalid for various other reasons. For example, a merchant may have a rule according to which a limited number of electronic coupons may be used in transactions within a certain period, such as within a same day or a same week. In another example, the electronic coupon is only valid for a predetermined period of time, and the transaction is performed outside this predetermined period of time. In both of those cases, the electronic coupon would be considered invalid and/or non-redeemable.

If it is determined that the electronic coupon was used in a previous transaction or that the indication of the electronic coupon provided is not associated with a valid electronic coupon, an indication that the electronic coupon is not valid or redeemable will be transmitted to at least one of the customer, via his or her mobile device for example, and of the merchant, via the payment terminal for example.

In one embodiment, if it is determined that the electronic coupon is valid and redeemable, an indication that the electronic coupon is valid and redeemable may be transmitted to at least one of the customer, via his or her mobile device for example, and of the merchant, via the payment terminal for example. The customer may then resume the transaction without using the electronic coupon or may cancel the transaction.

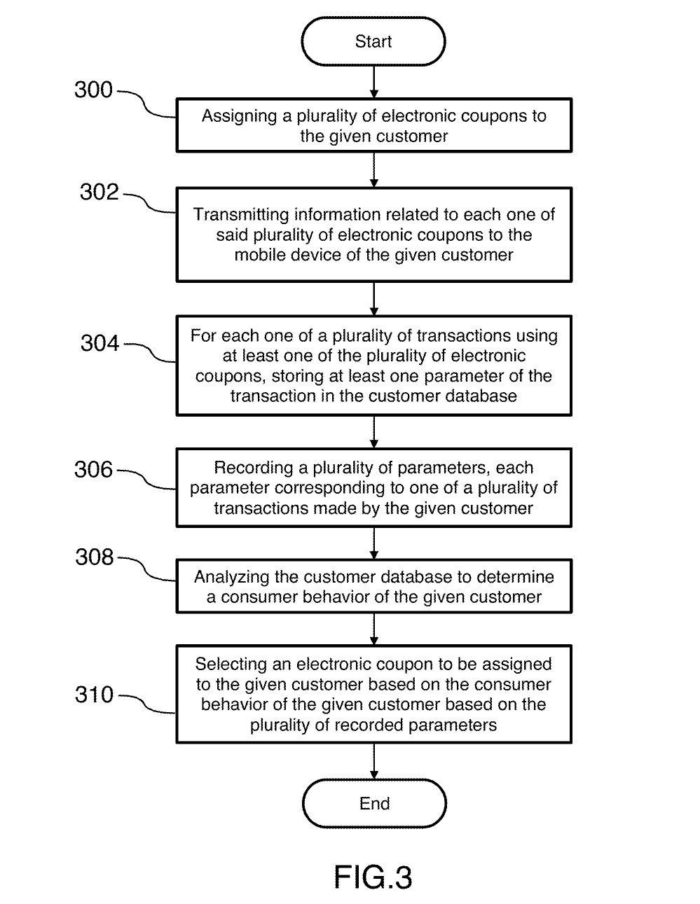

Now turning to FIG. 3, it will be appreciated that this system may further be used to compile statistics on the consumer behavior of the given customer. These statistics may help merchants and/or the mobile couponing system operator better target consumers by assigning electronic coupons selected according to this consumer behavior for each given customer.

In one embodiment illustrated in FIG. 3, a plurality of electronic coupons may be assigned to a given customer, in accordance with step 300. The electronic coupons may be assigned all at once, or one after the other over a predetermined period of time. For example, one or more electronic coupons may be assigned to the given customer every day, as part of a “daily deal” offer. Alternatively, other electronic coupon assignment scheme or schedules may be used.

According to step 302, information related to each one of said plurality of electronic coupons is therefore transmitted to the mobile device of the given customer.

According to step 304, at least one parameter of the transaction is stored in the customer database during or after each transaction in which at least one of the electronic coupons is used and the at least one transaction parameter is associated with the given customer in each transaction. The at least one transaction parameter may comprise an indication that the electronic coupon was used, a time at which the transaction was made, an initial amount of the transaction, a discounted amount of the transaction, a type of product purchased and a type of service purchased, and the like.

According to step 306, a plurality of those transaction parameters may be recorded for each given customer, each parameter corresponding to one of a plurality of transactions made by the given customer.

According to step 308, the customer database may then be analyzed to determine a consumer behavior of the given customer based on the plurality of recorded transaction parameters, and subsequently, future electronic coupons may be selected and assigned to the given customer based on the consumer behavior of this given customer, in accordance with step 310. For example, if the given customer uses electronic coupons in mostly the purchase of women's clothing, then electronic coupons providing financial benefits in women's clothing stores may be selected and assigned for this given customer to encourage the use of these electronic coupons, instead of electronic coupons providing financial benefits in men's clothing stores.

It will be appreciated that the customer database may be analyzed internally using the mobile couponing system. Alternatively, data from the customer database, including recorded transaction parameters, may be sent to an external data analysis service to be analyzed.

In another embodiment, the electronic coupon may be selected based on proximity to a merchant. More specifically, upon detection that the given customer is at a predetermined distance of a predetermined merchant, an electronic coupon which is redeemable at this predetermined merchant is assigned to the given customer and an indication of this electronic coupon is transmitted to the given customer via his or her mobile device. The predetermined distance from the merchant may be determined using an indication of the location of the given customer, which may be provided by a GPS tracker integrated into the given customer's mobile device, for example, or by other location determining means known to the skilled addressee.

It will be appreciated that this feature may also be used for a group of merchants instead of a single merchant. For example, when the given customer enters a shopping mall comprising a plurality of merchants, the mobile device of the given customer may enter a range of a wireless network provided within the shopping mall. Upon a detection that the mobile device is within range of the wireless network, one or more electronic coupons redeemable at corresponding stores located within the shopping mall may be assigned to the given customer and transmitted to the mobile device of the given customer. The given customer may therefore be encouraged to purchase articles or services from these merchants.

Alternatively, an indication of electronic coupons already assigned to the given customer and associated with the merchants in the shopping mall may be transmitted to the mobile device of the given customer upon detection that the mobile device is within range of the wireless network.

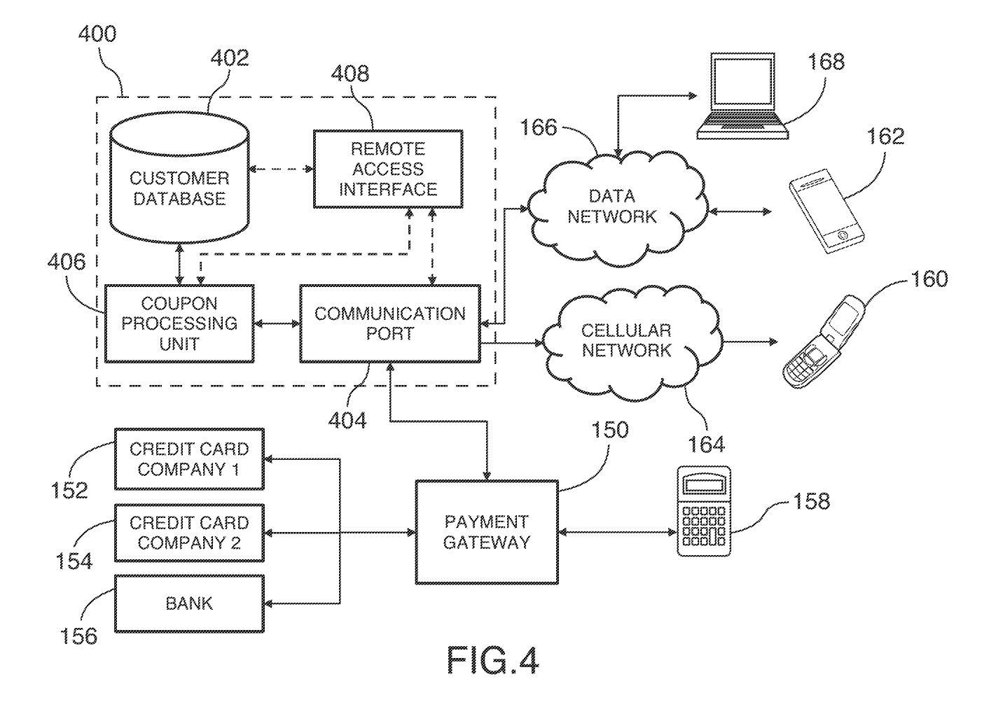

Now turning to FIG. 4, there is shown another embodiment of a mobile couponing system 400.

The mobile couponing system 400 is substantially similar to the mobile couponing system illustrated in FIG. 1. The mobile couponing system 400 comprises a customer database 402, a communication port 404 operatively connected to the customer database 402 and adapted to communicate with the payment gateway 150, and a coupon processing unit 406 operatively connected to the customer database 402 and to the communication port 404.

In this embodiment, the system 400 further comprises a remote access interface 408 adapted for enabling interaction with the customer database 402. The remote access interface 408 may be directly connected to the customer database 402, or may be operatively connected to the customer database 402 via the communication port 404 or the coupon processing unit 406. More specifically, the remote access interface 408 may comprise a server operatively connected via the communication port 404 to a data network, such as the Internet, and accessible from a general purpose computer 168, on a smartphone 162 or on any other device which can access the data network. The remote access interface 408 is adapted to enable the given customer to provide the corresponding customer contact parameter for the storing thereof in the customer database 402.

In the illustrated embodiment, the remote access interface 408 is accessible via the communication port 404 through the same data network 166 which is used to communicate with the smartphone 162 of the customer.

In one embodiment, the remote access interface 408 provides a web-based user interface which may advantageously be accessed on a web browser from any personal computer, smartphone or any other device connected to the Internet. Alternatively, the remote access interface 408 may be operatively connected to the customer database using other means known to the skilled addressee.

In one embodiment, the customer may use this web-based user interface to create a customer account associated with the customer. The customer account may be stored in the customer database, and comprises the corresponding customer contact parameter. The customer account may further comprise additional information related to the customer, such as the customer's age, gender, marital status, or the like.

The customer account may further comprise at least one coupon parameter selected by the customer. In this embodiment, the electronic coupon which is assigned to the given customer may be selected based on this coupon parameter. The coupon parameter may be selected from a group consisting of: a geographical location, at least one type of product, at least one type of service and at least one predetermined merchant. For example, a customer may elect to have only electronic coupons related to women's clothing assigned to her. In another example, a customer may elect that only electronic coupons redeemable in stores within a specific location or area are assigned to him or her.

In one embodiment, the remote access interface 408 is further adapted to enable the merchant to provide at least one criteria for enabling the coupon processing unit 406 to generate the electronic coupon based on the at least one criteria. In this embodiment, each merchant may create a merchant account to enable the merchant to manage the assigning of electronic coupons which are redeemable at its store or its stores. For example, a merchant may create a merchant account comprising an merchant identification such as the merchant's name, a selected login-password combination or the like, and at least one criteria such as a given discount on a specific product or a specific type of products. The coupon processing unit 406 may then generate one or more electronic coupons redeemable at that merchant such that the financial benefit associated with these electronic coupons comprises the given discount on the specific product or the specific type of products as selected by the merchant.

The merchant account may be stored in the customer database 402. Alternatively, the merchant account may be stored in a separate merchant database operatively connected to the communication port 404.

It will be appreciated that various criteria may be provided by the merchant. In another example, the criteria provided by the merchant may comprise a total number of electronic coupons which are to be generated. In yet another example, the criteria provided by the merchant may comprise a frequency at which indications of electronic coupons are transmitted to customers. In yet another example, the criteria provided by the merchant may comprise a selected group of customers to which the electronic coupons are to be assigned. The group of customers may be selected according to information provided by the customer in the customer account, as explained above, such as the customer's age, gender or the like.

In one embodiment, the criteria provided by the merchant may further comprise one or more “rules” related to the redeeming of electronic coupons at its store or stores. For example, the one or more rules may comprise a maximum number of electronic coupons which may be redeemed at the merchant's store or stores by a given customer within a predetermined period of time, such as within a day or a week. It will be appreciated that various other rules may be provided by the merchant.

In one embodiment, the rules are managed by the coupon processing unit 406. More specifically, when the indication of the electronic coupon is received during a transaction in which the electronic coupon is used, the coupon processing unit 406 may retrieve a rule associated with the electronic coupon from the customer database 402 or from the merchant database and may further apply the rule to the transaction. The coupon processing unit 406 may further transmit to the payment terminal 158 and/or to the mobile device of the customer, via the communication port 404, an indication of the rule applied to the transaction. For example, the coupon processing unit 406 may transmit to the payment terminal 158 an indication that the electronic coupon cannot be used in the transaction, and may further transmit to the payment terminal 158 an indication that the customer must wait until the next day to use the electronic coupon in a transaction.

It will also be appreciated that the remote access interface 408 further enables the merchant to access the customer database after the merchant account has been created, which advantageously enables the merchant to modify any criteria or rule related to electronic coupons redeemable at its store or stores.

It will further be appreciated that the term “store” as used herein comprises brick-and-mortar store, as known to the skilled addressee. In one embodiment, the term “store” may further comprise online stores, as also known to the skilled addressee.

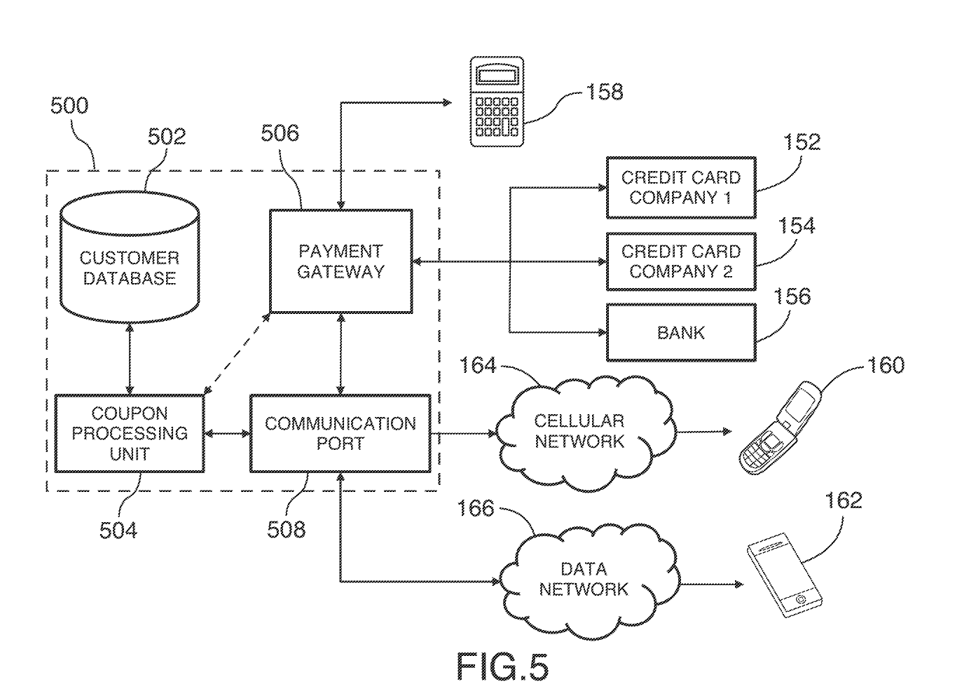

Now turning to FIG. 5, there is shown a mobile couponing system 500, in accordance with yet another embodiment.

The mobile couponing system 500 is substantially similar to the mobile couponing system 100 illustrated in FIG. 1. The mobile couponing system 500 comprises a customer database 502 and a coupon processing unit 504 operatively connected to the customer database 502.

In the embodiment illustrated in FIG. 5, the mobile couponing system 500 further comprises a payment gateway 506, which is similar to the payment gateway 150 illustrated in FIG. 1. As illustrated in FIG. 5, the payment gateway 506 may be directly connected to the coupon processing unit 504, or may be operatively connected to the coupon processing unit 504 via a communication port 508.

Similarly to the payment gateway 150, the payment gateway 506 is operatively connected to the payment terminal 158 and is adapted to detect the predetermined IIN provided in the payment terminal 158. The payment gateway 150 is further adapted to provide a first signal indicative of the detection of the predetermined IIN to the coupon processing unit 504.

Also similarly to the payment gateway 150, the payment gateway 506 is operatively connected to at least one financial institution, such as a credit card company 152, a second credit card company 154 and a bank 156. It will be appreciated that the payment gateway 506 may be connected to a different number and/or different types of financial institutions which process card payment information.

In one embodiment, the payment gateway 506 is an existing payment gateway, which is already operatively connected to at least one payment terminal. In another embodiment, the payment gateway 506 comprises a new payment gateway provided for the purpose of the mobile couponing system 500.

1. A method for enabling a transaction using electronic coupons, the method comprising:
providing a customer database comprising, for each customer of a plurality of customers, a corresponding customer contact parameter for enabling a communication with a mobile device of the customer;
assigning an electronic coupon to a given customer, the assigning comprising storing an indication of said electronic coupon in said customer database;
transmitting a predetermined issuer identification number (IIN) and information related to said electronic coupon to the mobile device of the given customer for use thereof in a transaction involving a payment terminal of a merchant;
in the course of the transaction, receiving an indication of a use of the electronic coupon, the receiving comprising the predetermined IIN being provided in the payment terminal of the merchant and being detected by a payment gateway of a payment processing entity operatively connected to the payment terminal, the receiving further comprising the indication of the electronic coupon being provided by said payment gateway upon detection of the predetermined IIN;
retrieving from the customer database an indication of a financial benefit associated with the use of the electronic coupon;
providing to the merchant the indication of the financial benefit such that the given customer is provided with the financial benefit upon completion of the transaction.

2. The method as claimed in claim 1, wherein the indication of said electronic coupon comprises a coupon identification specific to said electronic coupon.

3. The method as claimed in claim 2, wherein the coupon identification comprises the predetermined IIN.

4. The method as claimed in claim 1, wherein the indication of said electronic coupon comprises a customer identification associated with the given customer and a merchant identification associated with the merchant.

5. The method as claimed in claim 1, wherein the transmitting of the predetermined IIN and of the information related to said electronic coupon comprises transmitting the predetermined IIN and of the information related to said electronic coupon over a cellular network.

6. The method as claimed in claim 5, wherein the information related to said electronic coupon comprises a text message indicative of the electronic coupon.

7. The method as claimed in claim 1, further comprising storing at least one parameter of the transaction in the customer database and associating said at least one parameter to the given customer.

8. The method as claimed in claim 7, wherein the at least one parameter of the transaction is selected from a group consisting of: an indication that the electronic coupon was used, a time at which the transaction was made, an initial amount of the transaction, a discounted amount of the transaction, a type of product purchased and a type of service purchased.

9. The method as claimed in claim 1, wherein the assigning of the electronic coupon to the given customer comprises selecting the electronic coupon based on a coupon parameter selected by the given customer.

10. The method as claimed in claim 9, wherein the coupon parameter is selected from a group consisting of: a geographical location, at least one type of product, at least one type of service and at least one predetermined merchant.

11. The method as claimed in claim 1, wherein the assigning of the electronic coupon to the given customer comprises:
upon detection that the given customer is at a predetermined distance of a predetermined merchant, selecting the electronic coupon based on the predetermined merchant, the electronic coupon being redeemable at said predetermined merchant.

12. The method as claimed in claim 1, wherein the transaction comprises a purchase.

13. The method as claimed in claim 12, wherein the financial benefit comprises a discount on the purchase.

14. The method as claimed in claim 13, wherein the providing of the indication of the financial benefit to the merchant comprises:
obtaining an initial amount of the purchase from the merchant;
applying the discount to the initial amount to determine a discounted amount;
providing the discounted amount to the merchant.

15. The method as claimed in claim 1, wherein the predetermined IIN conforms to the ISO/IEC 7812 standard.

16. The method as claimed in claim 1, further comprising, after receiving the indication of the use of the electronic coupon, providing an indication that the electronic coupon is redeemable in the transaction.

17. The method as claimed in claim 16, wherein the indication that the electronic coupon is redeemable is provided to at least one of the given customer and the merchant.

18. A system for enabling a transaction using electronic coupons, the system comprising:
a customer database for storing, for each customer of a plurality of customers, a corresponding customer contact parameter for enabling a communication with a mobile device of the customer, the customer database being further adapted for storing an indication of an electronic coupon assigned to a given customer, the customer database being further adapted for storing an indication of a financial benefit associated with the use of the electronic coupon in a transaction;
a communication port operatively connected to the customer database and adapted to communicate with a payment gateway of a payment processing entity;
a coupon processing unit operatively connected to the customer database and to the communication port, the coupon processing unit being adapted to receive from the communication port a first signal indicative of a detection by the payment gateway of a predetermined issuer identification number (IIN) provided in a payment terminal associated with a transaction and operatively connected to the payment gateway, the first signal being further indicative of said electronic coupon, the coupon processing unit being further adapted to lookup in the customer database the indication of the electronic coupon corresponding to the first signal, the coupon processing unit being further adapted to retrieve from the customer database a corresponding indication of the financial benefit associated with the use of the electronic coupon corresponding to the first signal, the coupon processing unit being further adapted to provide to the communication port a second signal indicative of the corresponding indication of the financial benefit.

19. The system as claimed in claim 18, wherein the indication of the electronic coupon comprises a coupon identification specific to said electronic coupon.

20. The system as claimed in claim 19, wherein the coupon identification comprises the predetermined IIN.

21. The system as claimed in claim 18, wherein the indication of the electronic coupon comprises a customer identification associated with the given customer and a merchant identification associated with the merchant.

22. The system as claimed in claim 18, wherein the predetermined IIN comprises one of a plurality of IINs associated with the system.

23. The system as claimed in claim 18, wherein the predetermined IIN conforms to the ISO/IEC 7812 standard.

24. The system as claimed in claim 18, wherein the communication port is further adapted to communicate with the mobile device of the given customer using the corresponding customer contact parameter.

25. The system as claimed in claim 18, further comprising a remote access interface operatively connected to the customer database for enabling interaction with the customer database.

26. The system as claimed in claim 25, wherein the remote access interface is further adapted to enable the merchant to provide at least one criteria for generating the electronic coupon.

27. A system for enabling a transaction using electronic coupons, the system comprising:
a customer database for storing, for each customer of a plurality of customers, a corresponding customer contact parameter for enabling a communication with a mobile device of the customer, the customer database being further adapted for storing an indication of an electronic coupon assigned to a given customer, the customer database being further adapted for storing an indication of a financial benefit associated with the use of the electronic coupon in a transaction;
a payment gateway operatively connected to a payment terminal of a merchant, the payment gateway being adapted to detect a predetermined issuer identification number (IIN) provided in the payment terminal and being further adapted to provide a first signal indicative of the detection of said predetermined IIN, the first signal being further indicative of said electronic coupon;
a coupon processing unit operatively connected to the customer database and to the payment gateway, the coupon processing unit being adapted to receive the first signal from the payment gateway, the coupon processing unit being further adapted to lookup in the customer database the indication of the electronic coupon corresponding to the first signal, the coupon processing unit being further adapted to retrieve from the customer database a corresponding indication of the financial benefit associated with the use of the electronic coupon corresponding to the first signal, the coupon processing unit being further adapted to provide to the payment gateway a second signal indicative of the corresponding indication of the financial benefit.
